(19) United States
(12) Patent Application Publication
(10) Pub. No.: US 2020/0039863 A1
(43) Pub. Date: Feb. 6, 2020

(54) GLASS SHEET PROCESSING METHOD AND GLASS SHEET PROCESSING MOLD

(71) Applicant: AAC Technologies Pte. Ltd., Singapore city (SG)

(72) Inventors: Yuqin Yuan, Shenzhen (CN); Xiaogang Zhai, Shenzhen (CN); Bo Xu, Shenzhen (CN); Wei Su, Shenzhen (CN)

(21) Appl. No.: 16/527,040

(22) Filed: Jul. 31, 2019

(30) Foreign Application Priority Data
Aug. 3, 2018 (CN) 201810884315.5

(51) Int. Cl. C03B 23/03

(52) U.S. Cl. CPC C03B 23/0302

(57) ABSTRACT

The present disclosure a method includes the following steps: providing a forming die, wherein the molding mold includes a first male die, a first female die, a pressing block and a slide block; providing a glass sheet and hot-pressing the glass sheet to form prefabricated glass, wherein the prefabricated glass has a body portion and a bent portion, the bent portion bends and extends from an edge of the body portion toward a side away from the body portion; hot-pressing the bent portion, the first core of the male die and the second cavity of the pressing block are used to clamp the body portion and a part of the bent portion, such that a remaining part of the bent portion is exposed, the bent portion forms a second bent portion bending in the direction of the first core at an end of the first bent portion.

### FIELD OF THE DISCLOSURE

The present disclosure relates to product molding, and more particularly to a mold for processing a glass sheet processing method and a glass sheet processing mold.

### DESCRIPTION OF RELATED ART

With the development of the mobile internet era, more and more electronic devices are used in user's daily lives, such as mobile phones, tablets, notebooks, and so on. In addition to functional requirements, user's requirements for industrial product design of electronic devices are also more and more increasing, for example, in the prior art electronic devices, the industrial product design of the electronic devices are increasingly using three-dimensional glass substrate.

However, based on the aesthetic design and artistic pursuit, more and more three-dimensional glass substrates are designed with an inverted structure. The three-dimensional glass substrate with an inverted structure need to be shaped by a mold with an inverted structure, usually a row structure is also required for processing mold with an inverted structure, and which complicates the design of the mold and increases the space and functional requirements of the operating machine, it is disadvantageous for the production of a three-dimensional glass substrate having an inverted structure.

Therefore, it is desired to provide a mold for processing three-dimensional glass substrate and a method for three-dimensional glass substrate using the same to overcome the aforesaid problems.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a flow diagram of a glass sheet processing method according to a first embodiment of the present disclosure.

FIG. 2 is a schematic diagram showing a sectional structure before mold clamping of a pressing block and a first male die of a glass sheet processing mold according to the first embodiment of the present disclosure.

FIG. 3 is an enlarged diagram of a portion A of FIG. 2.

FIG. 4 is a schematic diagram showing a structure after changing mutual positions of the pressing block and the first male die of FIG. 2.

FIG. 5 is a schematic diagram showing a sectional structure after mold clamping of the pressing block and the first male die of FIG. 2.

FIG. 6 is a schematic diagram showing a sectional structure before mold clamping of a second female die and a second male die of a glass sheet processing mold according to a second embodiment of the present disclosure.

FIG. 7 is an enlarged diagram of a portion B of FIG. 6.

FIG. 8 is a schematic diagram showing a sectional structure after mold clamping of the second female die and the second male die of FIG. 6.

FIG. 9 is a schematic diagram showing a sectional structure before mold clamping of a first female die and a first male die of a glass sheet processing mold according to the second embodiment of the present disclosure.

FIG. 10 is a schematic diagram showing a sectional structure after mold clamping of the first female die and the first male die of FIG. 9.

FIG. 11 is an enlarged diagram of a portion C of FIG. 10.

FIG. 12 is a schematic diagram showing a first mating structure of a first female die and a slide block in a glass sheet processing mold according to the second embodiment of the present disclosure.

FIG. 13 is a schematic diagram showing a second mating structure of the first female die and the slide block in the glass sheet processing mold according to the second embodiment of the present disclosure.

FIG. 14 is a schematic diagram showing a third mating structure of the first female die and the slide block in the glass sheet processing mold according to the second embodiment of the present disclosure.

### DETAILED DESCRIPTION

The present disclosure will be hereinafter be described in detail below with reference to the attached drawings and embodiments thereof.

A first embodiment of the present disclosure relates to a glass sheet processing method. The core of this embodiment lies in: providing a molding mold, where the molding mold includes a first female die having a first cavity, a first male die having a first core, a slide block having an undercut molding surface, and a pressing block having a second cavity, a shape of the second cavity matching a shape of the first core, the undercut molding surface being a curved surface; providing a glass sheet and hot-pressing the glass sheet to form prefabricated glass, wherein the prefabricated glass has a body portion, and a bent portion bending and extending from an edge of the body portion, a bending angle of the bent portion being greater than or equal to 90 degrees, the bent portion comprising a first bent portion bending in a direction away from the first core; hot-pressing the bent portion, wherein the first core of the first male die and the second cavity of the pressing block clamp the body portion and a part of the bent portion such that a remaining part of the bent portion is exposed, the first female die being sleeved at a periphery of the pressing block, the undercut molding surface on a side of the slide block abutting against an end portion of the bent portion, other side of the slide block abutting against the first female die, the first female die being pushed in a first direction from a side of the pressing block toward a side of the first male die such that the first female die pushes the slide block to make the undercut molding surface press the bent portion toward the first core of the first male die in a second direction, the bent portion forming, at an end of the first bent portion, a second bent portion bending in a direction of the first core, the second bent portion being a curved surface matching the undercut molding surface, a bending direction of the first bent portion being opposite to a bending direction of the second bent portion, the first direction being a mold clamping direction of the first female die and the first male die, the second direction being a direction perpendicular to the first direction.

In the present embodiment, prefabricated glass having a body portion and a first bent portion is formed after hot-pressing a glass sheet; and a pressing block having a second cavity and a first male die having a first core are configured to clamp the body portion to fix the prefabricated glass. When the first female die moves in a first direction, the first female die pushes a slide block to slide in a second direction perpendicular to the first direction. That is, movement of the first female die in the first direction is transformed into sliding of the slide block in the second direction such that the undercut molding surface presses the bent portion toward the first core of the male die in the second direction, and a second bent portion bending toward the first core is formed at an end of the first bent portion, i.e., an undercut structure is formed. As such, a three-dimensional glass product having an undercut structure can be finally molded; and a complicated undercut structure is avoided from being configured on the first male die or the first female die. Therefore, design of the mold is more simple.

Implementation details of the glass sheet processing method of the present embodiment will be specifically described below. The following contents are intended merely to facilitate understanding of the implementation details provided, and are not indispensable for implementing the present solution.

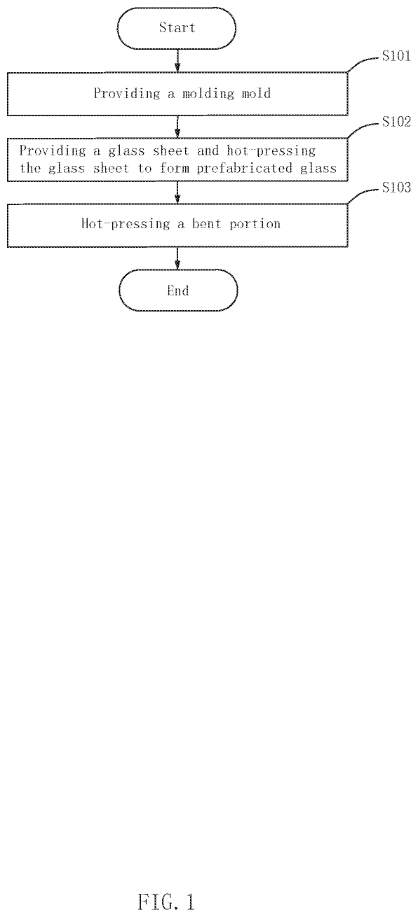

The glass sheet processing method in the present embodiment, as shown in FIG. 1, specifically includes the following.

Step 101: providing a molding mold.

Specifically, the molding mold includes a first male die 11, a first female die 12, a pressing block 13 and a slide block 14. Therein, the first male die 11 has a first core 110; the first female die 12 has a first cavity 120; the pressing block 13 has a third cavity 130; and the slide block 14 has an undercut molding surface 141. The undercut molding surface 141 is a curved surface. In the present embodiment, a shape of the second cavity 120 matches a shape of the first core 110.

In the present embodiment, the pressing block 13 is configured to clamp, together with the male die 11, a glass product; the first female die 12 surrounds a circumference of the pressing block 13 and can be subjected to mold clamping in a direction of the first male die 11; the slide block 14 abuts against the first female die 12; the undercut molding surface 141 is oriented toward a side of the first male die 11; and when the first female die 12 is subjected to mold clamping in the direction of the first male die 11, the first female die 12 can push the slide block 14 to slide toward the first core 110 of the first male die 11.

Step 102: providing a glass sheet and hot-pressing the glass sheet to form prefabricated glass.

Specifically, after a glass sheet 300 is hot-pressed, the formed prefabricated glass 200 has a body portion 21 and a bent portion 22. Therein, the bent portion 22 bends and extends from an edge of the body portion 21 toward a side away from the body portion 22. A bending angle formed by the bent portion 22 is greater than or equal to 90 degrees. The bent portion 22 includes a first bent portion 221 bending in a direction away from the first core 110.

In the present embodiment, hot-press molding of the prefabricated glass 200 can be achieved via a molding mold, which will be introduced below.

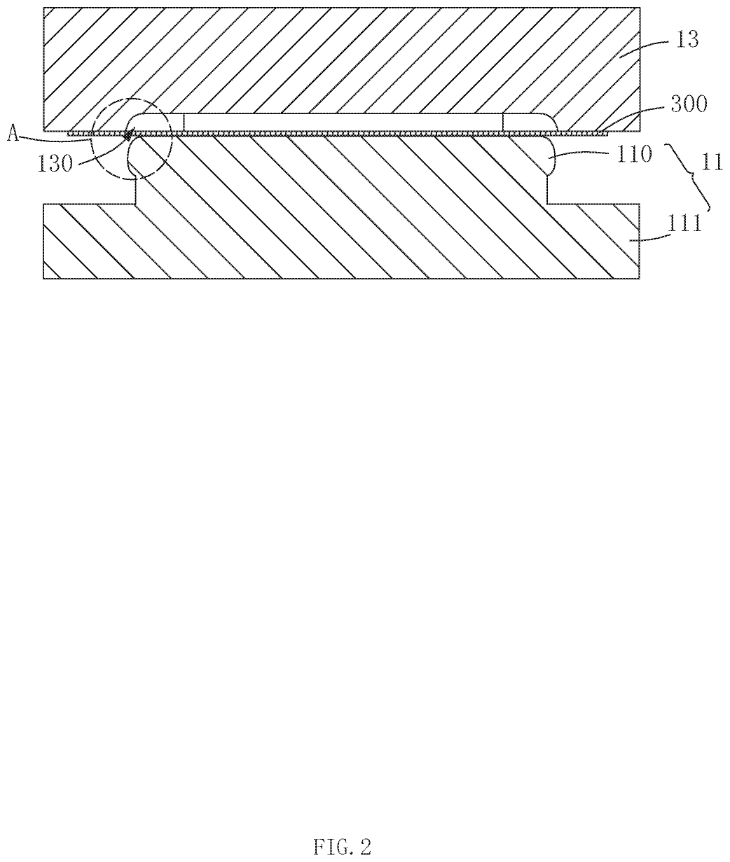

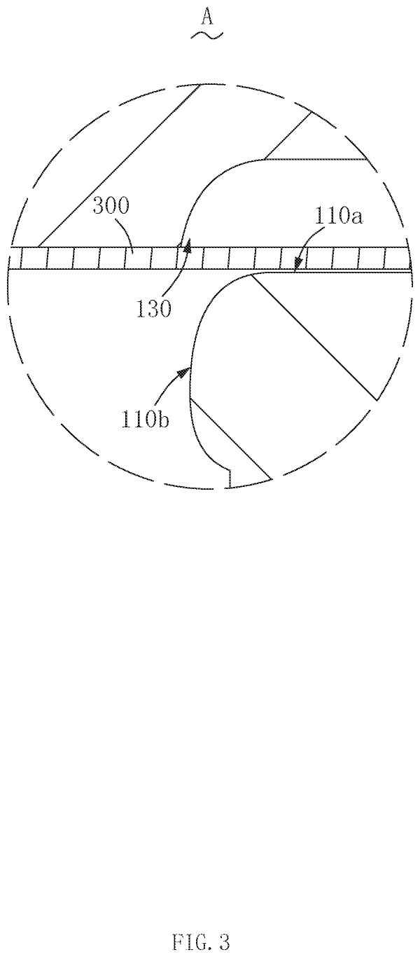

When hot-pressing of the prefabricated glass 200 is completed via a molding mold, the first male die 11 further includes a base 111 away from the pressing block 13. The first core 110 includes a top surface 110a oriented toward the pressing block 13, and a side surface 110b disposed at an edge of the top surface 110a and extending from the top surface 110a toward the base 111. The side surface 110b is a plane, or an arc surface/curved surface protruding in a direction away from a central axis of the first core 110. In the present embodiment, the side surface 110b is an arc surface/curved surface. It should be noted that, the above side surface 110b is shaped with respect to the sections/profiles as shown in FIGS. 2 and 3. In other words, that the side surface 110b is a plane means that the side surface 110b is embodied as a straight line in the section/profile; and that the side surface 110b is an arc surface/curved surface means that the side surface 110b is embodied as an arc line/curve line in the section/profile. As a matter of fact, as long as the side surface 110b with a steric structure is made a section/profile in the direction as shown in the Figure, the section line/profile line is a straight line, or an arc line/curve line, all falling within the protection scope of the present solution. This explanation is also applicable to the following descriptions and other embodiments. In order to avoid repetition, no details are described herein.

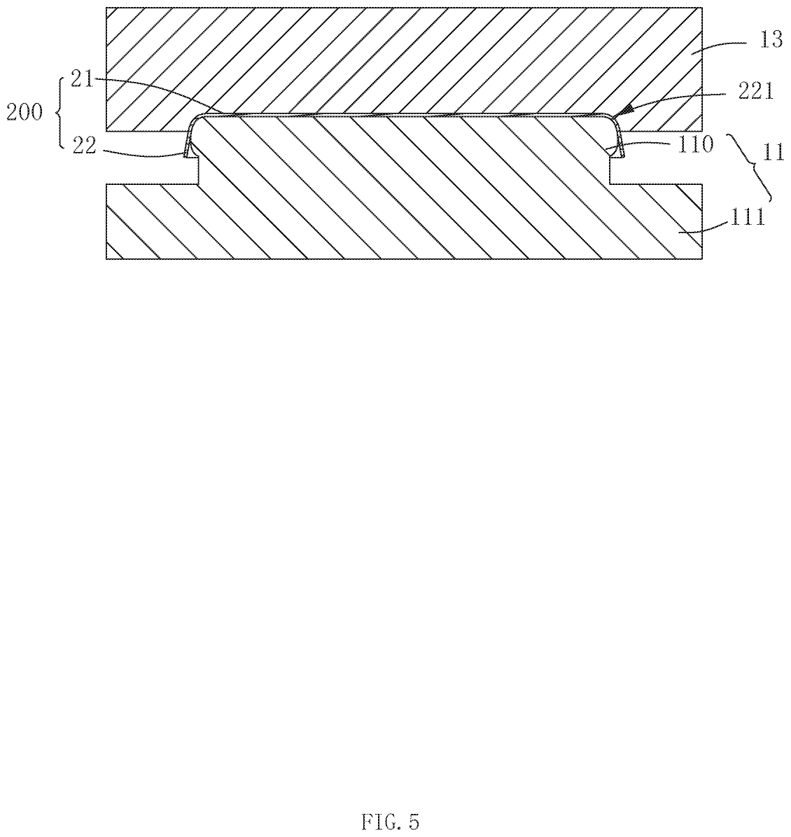

Specifically, the prefabrication hot-pressing of the prefabricated glass 200 includes the following steps (for the sake of better understanding, see FIGS. 2, 3, 4 and 5 in the second embodiment): supporting a central position of the glass sheet 300 with the first core 110 of the first male die 11; configuring the second cavity 130 of the pressing block 13 to directly face the top surface 110a; and hot-pressing, via the pressing block 13, the edge of the glass sheet 300 in a direction adjacent to the first male die 11 to form the first bent portion 221. As such, hot-press fabrication of the prefabricated glass 200 can be completed via the first male die 11 and the pressing block 13 having the above structures. In other words, by using only one set of molds, it is possible to complete two hot-pressing steps consisting of prefabricating and molding, which, as compared with the manner of using multiple sets of molds to respectively complete different hot-pressing steps, avoids the complicated working procedures during replacement of the multiple sets of molds and also reduces a complicated process formed by the use of multiple sets of molds, thereby facilitating production of the glass product and making it possible to further improve production efficiency.

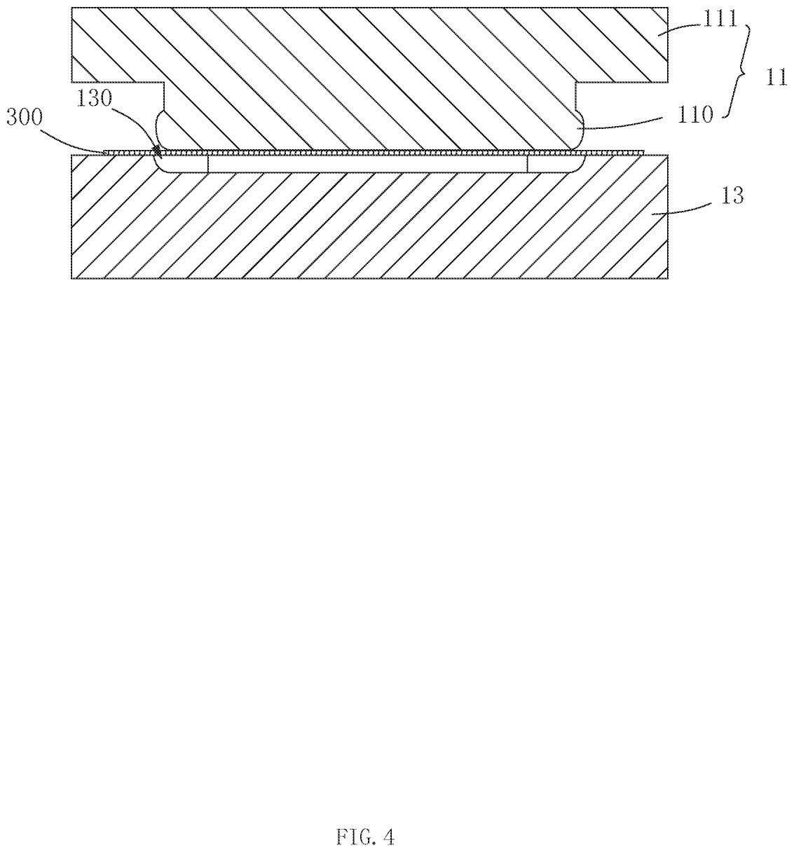

It is worth noting that, when the prefabricated glass 200 is molded by using the first male die 11 and the pressing block 13, positions of the first male die 11 and the pressing block 13 can be selected as required. For example, the first male die 11 is placed on the upper side and the pressing block 13 is placed on the lower side (see FIG. 4 in the second embodiment); alternatively, the first male die 11 is placed on the lower side and the pressing block 13 is placed on the upper side (see FIG. 2 in the second embodiment), without any limitations set herein.

In this step, preferably, a bending angle of the bent portion 22 is fabricated into a right angle or an obtuse angle, i.e., greater than or equal to 90 degrees, smaller than 180 degrees. Further, in the present embodiment, the bending angle is preferably a fillet. It could be understood that, the fillet, as compared with a sharp structure, contributes to dispersing external forces, that is, configuration of the fillet can enhance stress capabilities of the prefabricated glass 200 itself. It could be understood that, the above description is only an embodiment of the present solution, and does not constitute a limitation of the present solution in other embodiments. In other embodiments, the bending angle may further have other angles or shapes which are not listed herein for description.

Step 103: hot-pressing the bent portion.

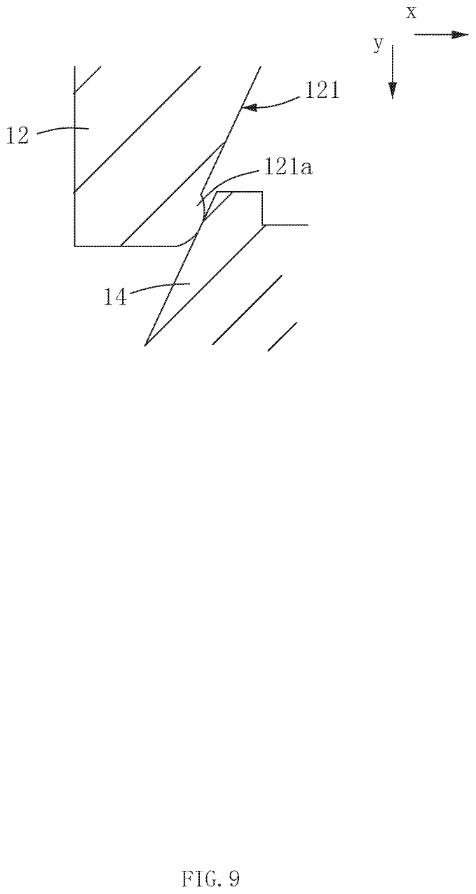

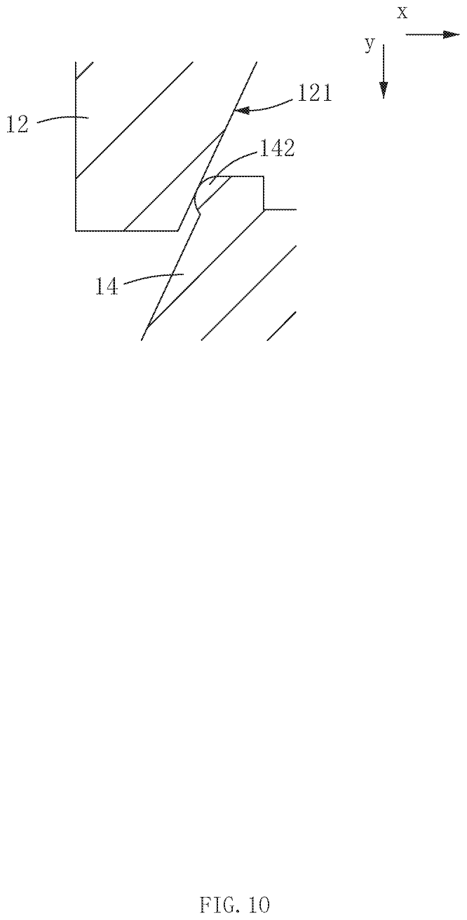

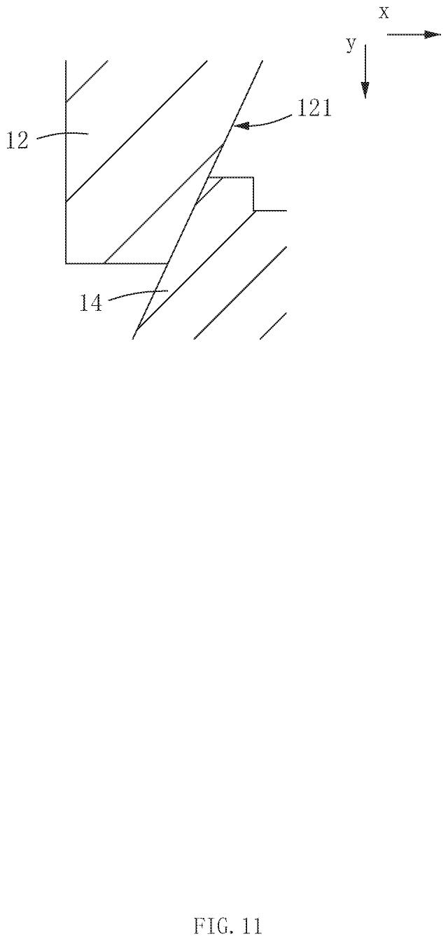

The first core 110 of the male die 11 and the second cavity 130 of the pressing block 13 are used to clamp the body portion 21 and a part of the bent portion 22, such that a remaining part of the bent portion 22 is exposed, as shown in FIG. 9. The first female die 12 is sleeved at a periphery of the pressing block 13. The undercut molding surface 141 on a side of the slide block 14 abuts against an end portion of the bent portion 22. Other side of the slide block 14 abuts against the first female die 12. The first female 12 is pushed in a first direction (a direction indicated by an arrow y in FIGS. 9, 12, 13 and 14) from a side of the pressing block 13 toward a side of the first male die 11 such that the first female die 12 pushes the slide block 14 to make the undercut molding surface 141 press the bent portion 22 toward the first core 110 of the first male die 11 in a second direction (a direction indicated by an arrow x in FIGS. 9, 12, 13 and 14). The bent portion 22 forms, at an end of the first bent portion 221, a second bent portion 222 bending in the direction of the first core 110, as shown in FIGS. 10 and 11. The second bent portion 222 is a curved surface matching the undercut molding surface 141. A bending direction of the bent portion 221 is opposite to a bending direction of the second bent portion 222 (the “opposite to a bending direction” means that: the first bent portion 221 bends in a direction away from the first core 110, and the second bent portion 222 bends in a direction adjacent to the first core 110). The first direction is a mold clamping direction of the first female die 12 and the first male die 11. The second direction is a direction perpendicular to the first direction.

In this step, an undercut structure on a lateral side of the glass product is completed by configuring a slide block 14 having a slide mechanism. Specifically, the prefabricated glass 200 (i.e., glass having no undercut structure) obtained in the step 102 is placed on the first male die 11. By configuring the first female 12 in contact with the slide block 14, when the first female die 12 is subjected to mold clamping toward the first male die 11 to press downward, the slide block 14 transforms up-down vertical movement of the first female die 12 into horizontal movement (the “vertical” and “horizontal” herein include directions of substantial “vertical” and “horizontal”). The slide block 14 moves in a direction adjacent to the first core 110 of the first male die 11. In this way, the undercut molding surface 141 can squeeze a lateral side of the glass product, i.e., an end of the first bent portion 221. After the first female die 12 presses downward to complete mold clamping, the undercut molding surface 141 of the slide block 14 also hot-presses to a desired degree, i.e., a glass product having an undercut structure can be molded.

It is worth noting that, when the body portion 21 and a part of the bent portion 22 are clamped by using the first male die 11 and the pressing block 13, positions of the first male die 11 and the pressing block 13 can also be selected as required. Moreover, the first female die 12 is located on a same side as the pressing block 13, and the slide block 14 and the first male die 11 are located on a same side. For example, the first male die 11 and the slide block 14 are located on the upper side, and the pressing block 13 and the first female die 12 are located on the lower side; alternatively, the first male die 11 and the slide block 14 are located on the lower side, and the pressing block 13 and the first female die 12 are located on the upper side, without limitations set herein.

In general, the present embodiment implements a method of molding a glass product having an undercut structure via a mold having a slide structure. Therein, molding of the glass product having an undercut structure can comprise multiple steps of hot-pressing. The present embodiment lists two steps of hot-pressing, but may not be limited to two steps in practical application. For example, if the prefabricated glass 200 in the step 102 is not hot-pressed to a desired degree one time, the prefabricated glass 200 is molded additionally two or more times, which also falls into the protection scope of the present solution. It is also the same case for the step 104. Detailed are not described herein.

In the step 102 listed in the present embodiment, a glass sheet 300 is molded via hot-pressing into prefabricated glass 200 having no undercut structure and having a bending angle greater than or equal to 90 degrees. In the listed step 104, the prefabricated glass 200 is hot-pressed into a glass product having a final undercut structure by designing a slide structure. Therein, the slide structure completes hot-pressing of the undercut structure via mating between the slide block 14 and the first female die 12. In other words, successful molding of the glass product having an undercut structure is achieved via the undercut molding surface 141 of the slide block 14 by transforming up-down vertical movement of the first female die 12 into left-right horizontal movement of the slide block 14.

It should be noted that, in other embodiments of the present solution, specific implementation details of each step may also adopt other manners. For example, regarding “Step 102: providing a glass sheet and hot-pressing the glass sheet to form prefabricated glass”, the prefabricated glass 200 can also be molded by hot-pressing via a separately provided pre-molding mold, which will be introduced below.

When the separately provided pre-molding mold is configured to hot-press the glass sheet 300 to form the prefabricated glass 200, the pre-molding mold specifically includes a second male die 15 having a second cavity 150 and a second female die 15 having a third cavity 160. Therein, the second male die 15 further includes a base 151 away from the third cavity 150; the second core 150 includes a top surface 150a oriented toward the third cavity 160, and a side surface 150b disposed at an edge of the top surface 150a and extending from the top surface 150a to the base 151 in a direction away from a central axis of the second core 120, where the side surface 150b is a plane.

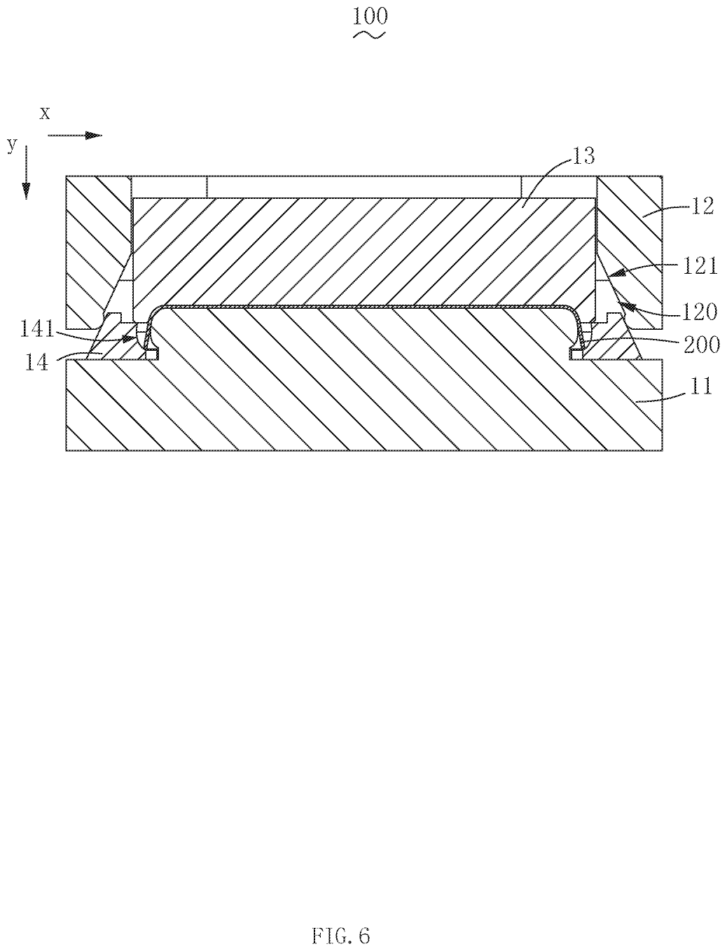

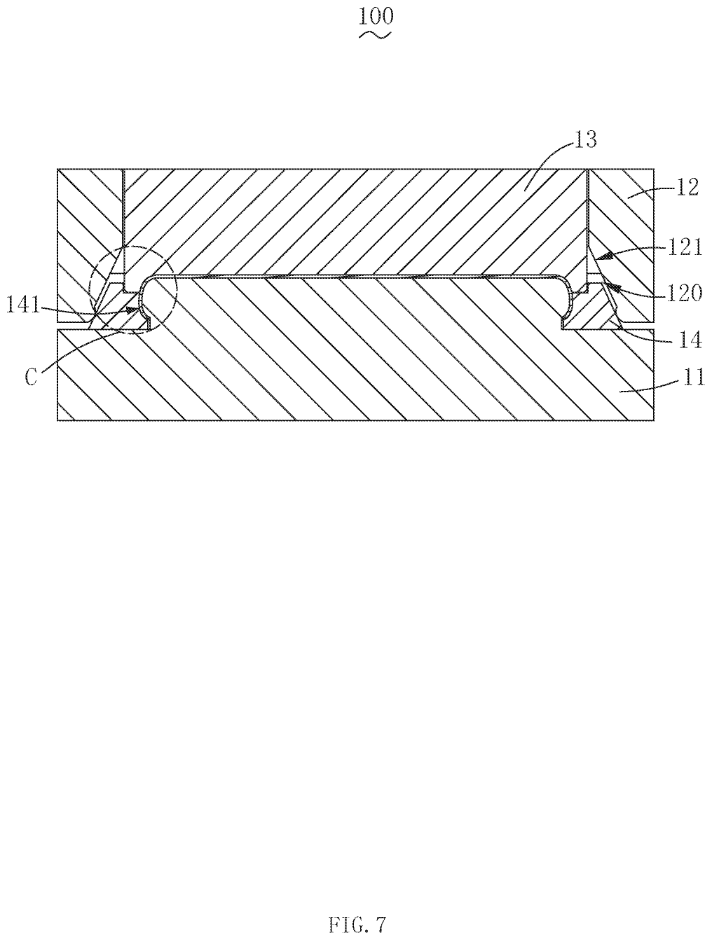

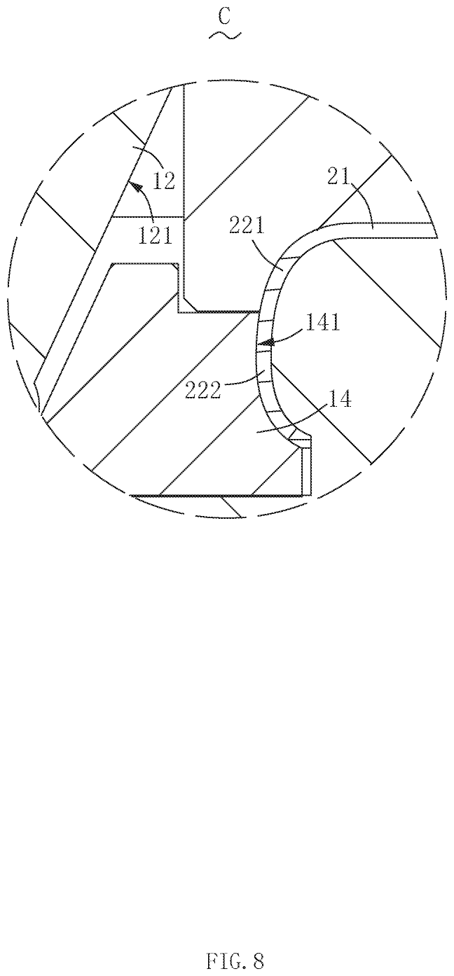

At this time, the process of hot-pressing the prefabricated glass 200 specifically includes the following steps (for the sake of better understanding, see FIGS. 6, 7 and 8 in the second embodiment): providing a pre-molding mold; supporting a central position of the glass sheet 300 with the top surface 150a of the second male die 15; configuring the third cavity 160 of the second female die 16 to directly face the top surface 150a; and hot-pressing, via the second female die 16, an edge of the glass sheet 300 in a direction adjacent to the second male die 15, to form the first bent portion 221. The structures and designs of the second male die 15 having the top surface 150a and the side surface 150b and the second female die 16 mating therewith are relatively simple, thereby reducing requirements for the template structure in the hot-press prefabrication process of the glass sheet 300.

It is worth mentioning that, when the second male die 15 and the second female die 16 are configured to mold the prefabricated glass 200, positions of the second male die 15 and the second female die 16 can be selected as required. For example, the second male die 15 is placed on the upper side and the second female die 16 is placed on the lower side; alternatively, the second male die 15 is placed on the lower side and the second female die 16 is placed on the upper side, without any limitations set herein.

A second embodiment of the present disclosure relates to a glass sheet processing mold 100, as shown in FIGS. 2-14, and the present embodiment is a glass sheet processing mold 100 corresponding to the glass sheet processing method in the first embodiment.

The glass sheet processing mold 100 includes a first male die 11 having a first core 110 and a first female die 12 having a first cavity 120, and further includes a slide 14 having an undercut molding surface 141 and a pressing block 13 having a second cavity 130. A shape of the second cavity 130 matches a shape of the first core 110. The slide block 14 is configured to hot-press prefabricated glass 200. The undercut molding surface 141 is a curved surface. The prefabricated glass 200 includes a body portion 21, and a bent portion 22 bending and extending from an edge of the body portion 21. A bending angle of the bent portion 22 is greater than or equal to 90 degrees. The bent portion 22 includes a first bent portion 221 bending in a direction away from the first core 120. The first core 110 of the first male die 11 and the second cavity 130 of the pressing block 13 are configured to clamp the body portion 21 and a part of the bent portion 22 such that a remaining part of the bent portion 22 is exposed. The first female die 12 is sleeved at a periphery of the pressing block 13. The undercut molding surface 141 on a side of the slide block 14 abuts against an end portion of the bent portion 22. Other side of the slide block 14 abuts against the first female die 12. The first female die 12 is pushed in a first direction (a direction indicated by an arrow y in FIGS. 9, 12, 13 and 14) from a side of the pressing block 13 toward a side of the first male die 11 such that the first female die 12 pushes the slide block 14 to make the undercut molding surface 141 press the bent portion 22 toward the first core 110 of the first male die 11 in a second direction (a direction indicated by an arrow x in FIGS. 9, 12, 13 and 14). The bent portion 22 forms, at an end of the first bent portion 221, a second bent portion 222 bending in a direction of the first core 110, as shown in FIGS. 10 and 11. The second bent portion 222 is a curved surface matching the undercut molding surface 141. A bending direction of the first bent portion 221 is opposite to a bending direction of the second bent portion 222. The first direction is a mold clamping direction of the first female die and the first male die. The second direction is a direction perpendicular to the first direction.

In the present embodiment, a pressing block 13 having a second cavity 130 and a first male die 11 having a first core 110 are configured to clamp the body portion 21 and a part of the bent portion 22 to fix the prefabricated glass 200. When the first female die 12 moves in a first direction, the first female die 12 pushes a slide block 14 to slide in a second direction perpendicular to the first direction. That is, movement of the first female die 12 in the first direction is transformed into sliding of the slide block 14 in the second direction such that the undercut molding surface 141 presses the bent portion 22 toward the first core 110 of the male die 11 in the second direction, and a second bent portion 222 bending toward the first core 110 is formed at an end of the first bent portion 221, i.e., the glass product is made to have an undercut structure. As such, a three-dimensional glass product having an undercut structure can be finally molded; and a complicated undercut structure is avoided from being configured on the first male die 11 or the first female die 12. Therefore, design of the mold is more simple.

It should be noted that, the “edge” may refer to an entire surrounding/circumferential edge, or may also refer to as a partial edge (such as two sides), without any limitations set herein.

Implementation details of the present embodiment will be specifically described below. The following contents are intended merely to facilitate understanding of the implementation details provided, and are not indispensable for implementing the present solution.

In the present embodiment, in order to reduce the number of tools used and avoid complicated working procedures during replacement of multiple sets of molds in the fabrication process, molding of the above prefabricated glass 200 can be achieved via the pressing block 13 and the first male die 11 in the present embodiment. Specifically, the first male die 11 further includes a base 111 away from the pressing block 13. The first core 110 includes a top surface 110a oriented toward the pressing block 13, and a side surface 110b disposed at an edge of the top surface 110a and extending from the top surface 110a toward the base 111. The side surface 110b is a plane, or an arc surface/curved surface protruding in a direction away from a central axis of the first core 110. As such, by using only one set of molds, it is possible to complete two hot-pressing steps consisting of prefabricating and molding, which, as compared with the manner of using multiple sets of molds to respectively complete different hot-pressing steps, not only avoids the complicated working procedures during replacement of the multiple sets of molds but also reduces a complicated process formed by the use of multiple sets of molds, thereby facilitating production of the glass product and making it possible to further improve production efficiency.

It should be noted that, the “edge” may refer to an entire surrounding/circumferential edge, or may also refer to as a partial edge (such as two sides), without any limitations set herein.

Further, when the pre-molding mold is configured to complete the prefabricated glass 200, a bending angle between the top surface 110a and the side surface 110b of the first male die 11 is preferably a right angle or an obtuse angle; and the right angle or obtuse angle is a fillet. The fillet, as compared with a sharp structure, contributes to dispersing external forces, that is, configuration of the fillet can enhance stress capabilities of the prefabricated glass 200 itself.

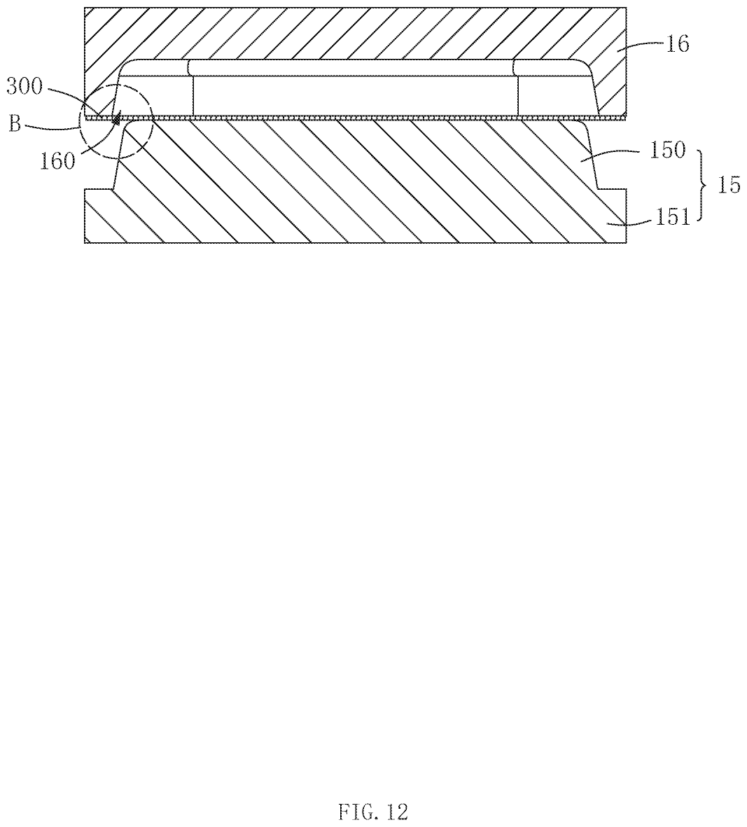

In the present embodiment, the slide block 14 abuts against a bevel 121 of the first female die 12. It is worth mentioning that, specific manners of contact between the slide block 14 and the first female die 12 are plural. For example, a location of the first female die 12 directly facing the slide block 14 is provided with a protrusion 121a against which the slide block 14 abuts and via which the first female die 12 pushes the slide block 14. Therein, a surface of the protrusion 121a is an arc surface, and a side of the slide block 14 facing the protrusion 121a is an inclined plane, as shown in FIG. 12. As such, an area of contact between the slide block 14 and the first female die 12 is reduced. In other words, it is possible to reduce a force of friction between the slide block 14 and the first female die 12, which facilitates the first female die 12 in pushing the slide block 14.

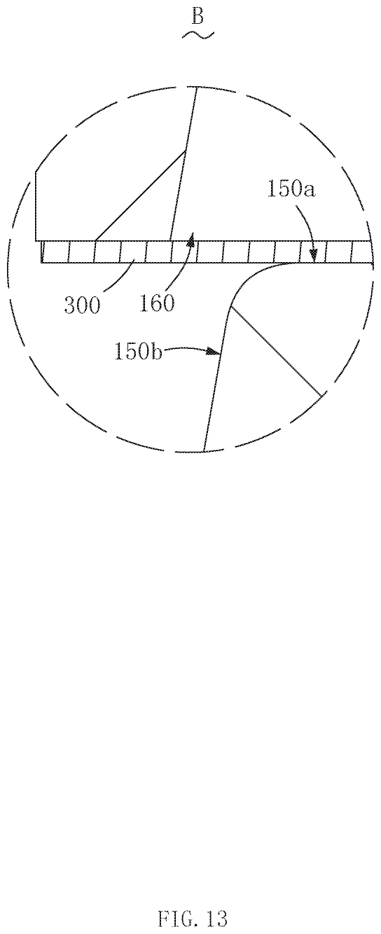

A specific manner of contact between the slide block 14 and the first female die 12 can also be as follows. A location of the slide block 14 directly facing the first female die 12 is provided with a protrusion 142 via which the slide block 14 abuts against the first female die 12 and via which the first female die 12 pushes the slide block 14. Therein, a surface of the protrusion 142 is an arc surface, and a side of the first female die 12 facing the protrusion 142 is an inclined plane, as shown in FIG. 13. As such, an area of contact between the slide block 14 and the first female die 12 is reduced. In other words, it is possible to reduce a force of friction between the slide block 14 and the first female die 12, which facilitates the first female die 12 in pushing the slide block 14.

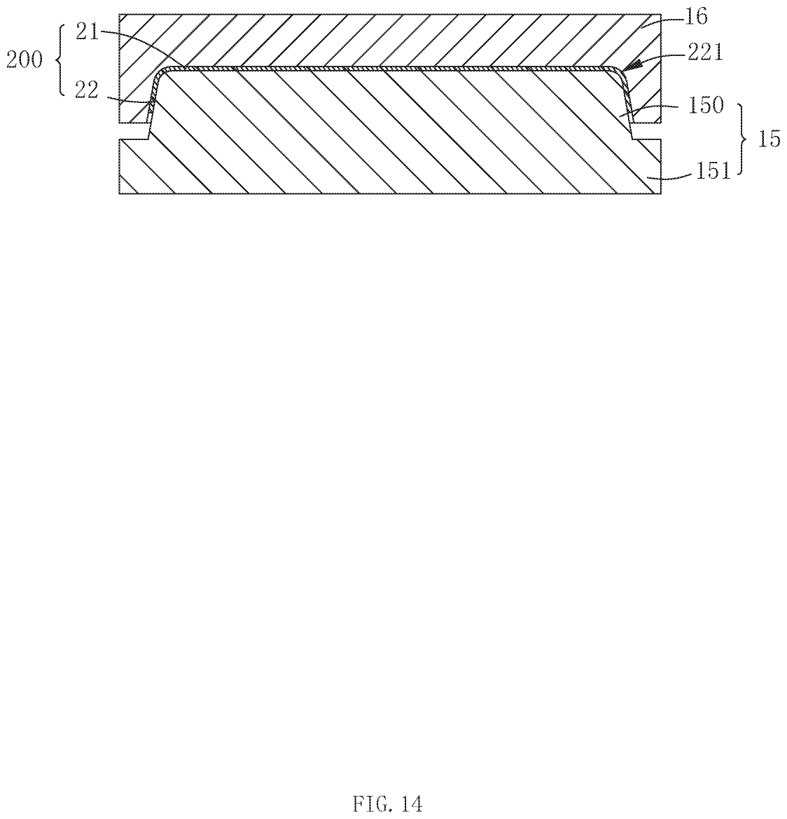

It could be understood that, a specific manner of contact between the slide block 14 and the first female die 12 can also be as follows. A side of the slide block 14 directly facing the first female die 12 is an inclined plane; a side of the first female die 12 directly facing the slide block 14 is also an inclined plane; and the first female die 12 pushes the slide block 14 via the plane, as shown in FIG. 14. Since an area of contact between the slide block 14 and the first female die 12 is rather large, a supporting area of the first female die 12 for the slide block 14 is also rather large; and when the first female die 12 pushes the slide block 14, the slide block 14 can slide in a relatively stable manner.

In addition, it should be noted that there are many manners of producing prefabricated glass 200 in the present embodiment. In other embodiments of the present solution, in addition to prefabrication hot-pressing via the first male die 11 and the first female die 12, it is also possible to prefabricate and hot-press via a pre-molding mold. The pre-molding mold includes a second male die 15 and a second female die 16, as shown in FIGS. 6, 7 and 8, which will be introduced below.

The pre-molding mold includes a second male die 15 having a second core 150 and a second female die 16 having a third cavity 160. Therein, the second male die 15 further includes a base 151 away from the third cavity 160; the second core 150 includes a top surface 150a oriented toward the third cavity 160, and a side surface 150b disposed at an edge of the top surface 150a and extending from the top surface 150a to the base 151 in a direction away from a central axis of the third cavity 160, where the side surface 150b is a plane. The structures and designs of the second male die 15 having the top surface 150a and the side surface 150b and the second female die 16 mating therewith are relatively simple, thereby reducing requirements for the template structure in the hot-press prefabrication process of the glass sheet 300, particularly facilitating implementation of mass-production of prefabricated glass when it is needed to mass-produce the prefabricated glass.

It should be noted that, the “edge” may refer to an entire surrounding/circumferential edge, or may also refer to as a partial edge (such as two sides), without any limitations set herein.

Further, when the pre-molding mold is configured to complete the prefabricated glass 200, a bending angle between the top surface 150a and the side surface 150b of the second male die 15 is preferably a right angle or an obtuse angle; and the right angle or obtuse angle is a fillet. The fillet, as compared with a sharp structure, contributes to dispersing external forces, that is, configuration of the fillet can enhance stress capabilities of the prefabricated glass 200 itself.

It should be noted that, since the present embodiment is a processing mold adapted to the first embodiment, various details described in the first embodiment are applicable to the present embodiment, and various details described in the present embodiment are also applicable to the first embodiment. In order to avoid repetition, details are not described herein.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A glass sheet processing method, comprising:
providing a molding mold, wherein the molding mold includes a first female die having a first cavity, a first male die having a first core, a slide block having an undercut molding surface, and a pressing block having a second cavity, a shape of the second cavity matching a shape of the first core, the undercut molding surface being a curved surface;
providing a glass sheet, clamping the glass sheet between the first male die and the pressing block, and hot-pressing the glass sheet to form prefabricated glass, wherein the prefabricated glass has a body portion, and a bent portion bending and extending from an edge of the body portion, a bending angle of the bent portion being greater than or equal to 90 degrees, the bent portion comprising a first bent portion bending in a direction away from the first core;
hot-pressing the bent portion, wherein the first core of the first male die and the second cavity of the pressing block clamp the body portion and a part of the bent portion such that a remaining part of the bent portion is exposed, the first female die being sleeved at a periphery of the pressing block, the undercut molding surface on a side of the slide block abutting against an end portion of the bent portion, other side of the slide block abutting against the first female die, the first female die being pushed in a first direction from a side of the pressing block toward a side of the first male die such that the first female die pushes the slide block to make the undercut molding surface press the bent portion toward the first core of the first male die in a second direction, the bent portion forming, at an end of the first bent portion, a second bent portion bending in a direction of the first core, the second bent portion being a curved surface matching the undercut molding surface, a bending direction of the first bent portion being opposite to a bending direction of the second bent portion, the first direction being a mold clamping direction of the first female die and the first male die, the second direction being a direction perpendicular to the first direction.

2. A glass sheet processing mold, comprising: a first male die having a first core, and a female die having a first cavity, and further comprising: a slide block having an undercut molding surface, and a pressing block having a second cavity, a shape of the second cavity matching a shape of the first core, the slide block being configured to hot-press prefabricated glass, the undercut molding surface being a curved surface, wherein the prefabricated glass comprises a body portion, and a bent portion bending and extending from an edge of the body portion, a bending angle of the bent portion being greater than or equal to 90 degrees, the bent portion comprising a first bent portion bending in a direction away from the first core, the first core of the first male die and the second cavity of the pressing block clamping the body portion and a part of the bent portion such that a remaining part of the bent portion is exposed, the first female die being sleeved in a periphery of the pressing block, the undercut molding surface on a side of the slide block abutting against an end portion of the bent portion, other side of the slide block abutting against the first female die, the first female die being pushed in a first direction from a side of the pressing block toward a side of the first male die such that the first female die pushes the slid block to make the undercut molding surface press the bent portion toward the first core of the first male die in a second direction, the bent portion forming, at an end of the first bent portion, a second bent portion bending in a direction of the first core, the second bent portion being a curved surface matching the undercut molding surface, a bending direction of the first bent portion being opposite to a bending direction of the second bent portion, the first direction being a mold clamping direction of the first female die and the first male die, the second direction being a direction perpendicular to the first direction.

3. The glass sheet processing mold according to claim 2, wherein the first male die further comprises a base away from the pressing block, and wherein the first core comprises a top surface oriented toward the pressing block, and a side surface disposed at an edge of the top surface and extending from the top surface toward the base, the side surface being a plane or the side surface being an arc surface protruding in a direction away from a central axis of the first core, the top surface and the side surface being configured to mold via hot-pressing, together with the second cavity of the pressing block, prefabricated glass having the first bent portion.

4. The glass sheet processing mold according to claim 2, wherein a location of the first female die directly facing the slide block is provided with a protrusion, the slide block abutting against the protrusion, the first female die pushing the slide block via the protrusion.

5. The glass sheet processing mold according to claim 3, wherein a location of the first female die directly facing the slide block is provided with a protrusion, the slide block abutting against the protrusion, the first female die pushing the slide block via the protrusion.

6. The glass sheet processing mold according to claim 2, wherein a location of the slide block directly facing the first female die is provided with a protrusion, the slide block abutting against the first female die via the protrusion, the first female die pushing the slide block by pushing the protrusion.

7. The glass sheet processing mold according to claim 3, wherein a location of the slide block directly facing the first female die is provided with a protrusion, the slide block abutting against the first female die via the protrusion, the first female die pushing the slide block by pushing the protrusion.

8. The glass sheet processing mold according to claim 2, where a side of the slide block directly facing the first female die is a plane, a side of the first female die directly facing the slide block is also a plane, the first female die pushing the slide block via the plane.

9. The glass sheet processing mold according to claim 3, where a side of the slide block directly facing the first female die is a plane, a side of the first female die directly facing the slide block is also a plane, the first female die pushing the slide block via the plane.
